(19) United States
(12) Patent Application Publication
(10) Pub. No.: US 2022/0412484 A1
(43) Pub. Date: Dec. 29, 2022

(54) CABLE OR PIPE SUPPORTS

(71) Applicant: JCCO 330 LIMITED, Manchester (GB)

(72) Inventor: Paul Davidson, Macclesfield (GB)

(21) Appl. No.: 17/658,511

(22) PCT Filed: Oct. 5, 2020
(86) PCT No.: PCT/GB2020/052446

§ 371 Date: Apr. 8, 2022

(30) Foreign Application Priority Data
Oct. 9, 2019 (GB) 1914586.1

(51) Int. Cl. F16L 3/11; F16L 3/10; F16L 3/02; F16L 3/23

(52) U.S. Cl. CPC F16L 3/11; F16L 3/1033; F16L 3/1025; F16L 3/02; F16L 3/23

(57) ABSTRACT

A support (10) apparatus suitable for supporting a cable or a pipe (12), wherein the support apparatus once installed to a suitable supporting surface, is arranged to provide an accommodation space which is at least partially open at an opening such that the cable or pipe may be introduced into the accommodation space through the opening.

The present invention relates to improved apparatus and techniques for suspending pipes, cable or other utilities from a ceiling or other surface. It is often required to provide cable or pipe runs for extended distances within a building. It is known to provide such runs in the form of trapezes, comprising a series of suspension points supporting a tray to support the cables or pipes. These structures are often concealed behind a false ceiling or may be exposed in, for instance, a service corridor or parking garage.

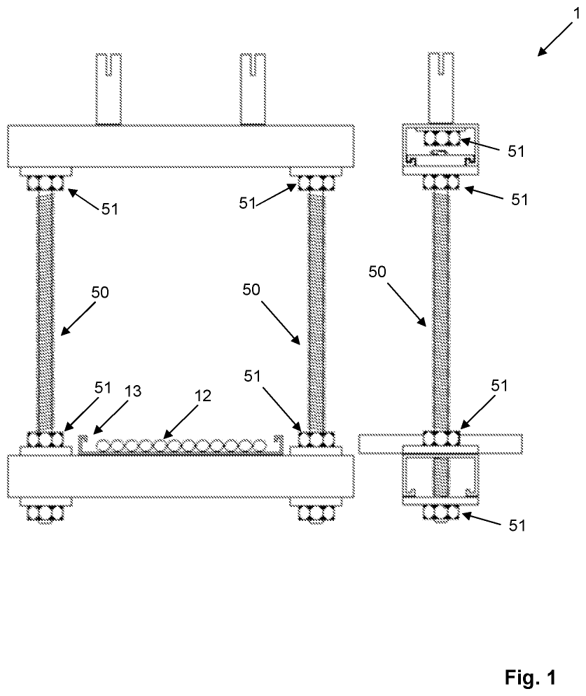

FIG. 1 shows a prior art trapeze 1. It is well known in the art and so a detailed description is not herein presented. However, of note in the present context, the construction is relatively complex and requires a significant amount of operator time to prepare and construct. For instance the two threaded bars 50 which form each element require cutting to length, which can result in sharp burrs which can be dangerous and impede the passage of one of the many nuts 51. Further, each nut 51 must be threaded into position, which can be time-consuming as each element includes at least eight nuts 51, as shown in the side view of FIG. 1.

Accordingly, there is a desire to address shortcomings in the prior art, whether mentioned herein or not.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

FIG. 1 shows a prior art trapeze;

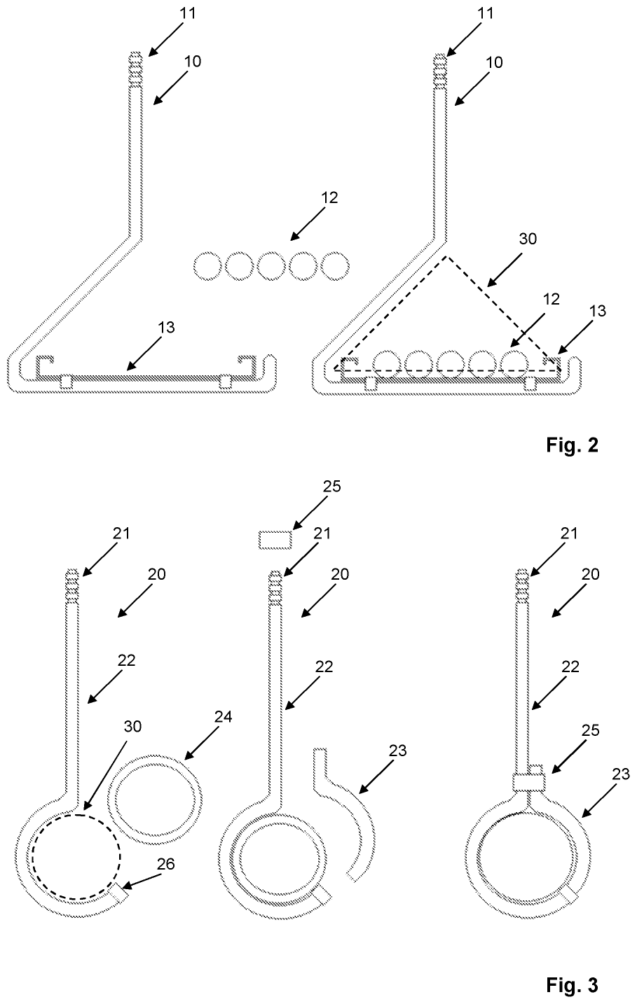

FIG. 2 shows a support according to an embodiment of the present invention;

FIG. 3 shows a support according to an embodiment of the present invention;

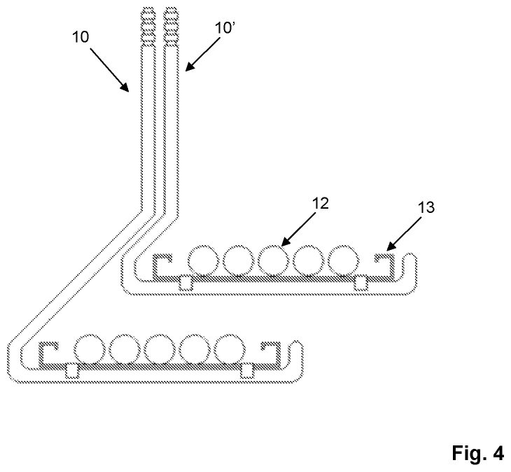

FIG. 4 shows a pair of supports according to an embodiment of the present invention;

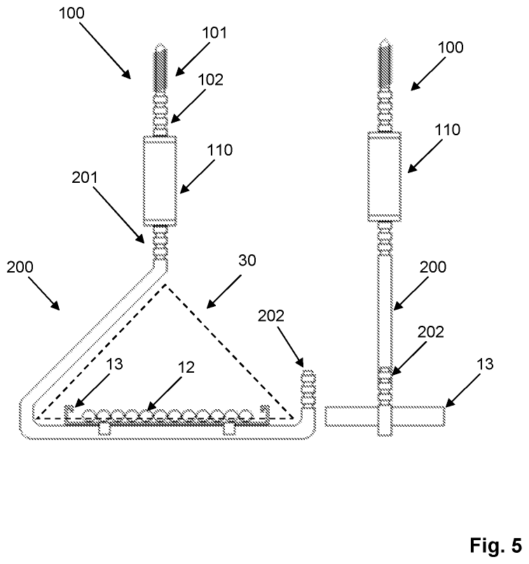

FIG. 5 shows a support according to an embodiment of the present invention;

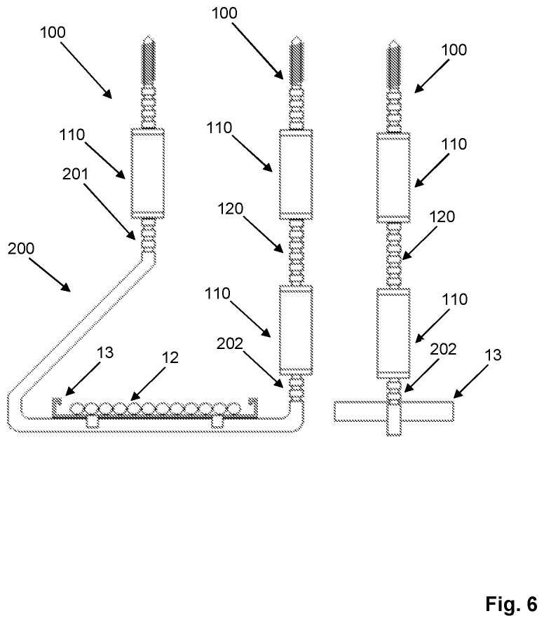

FIG. 6 shows a support according to an embodiment of the present invention;

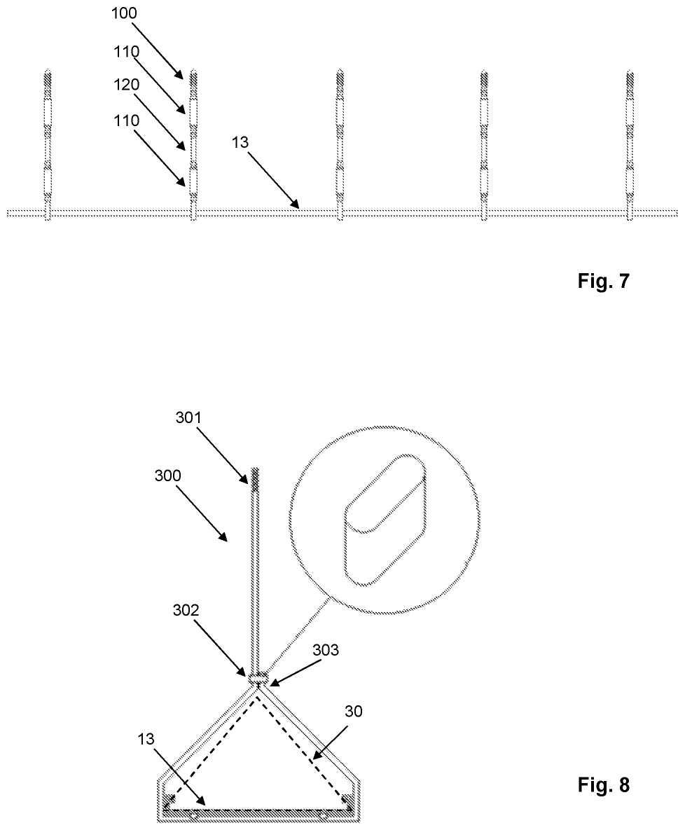

FIG. 7 shows a side view of a plurality of supports according to an embodiment of the present invention;

FIG. 8 shows a support according to an embodiment of the present invention;

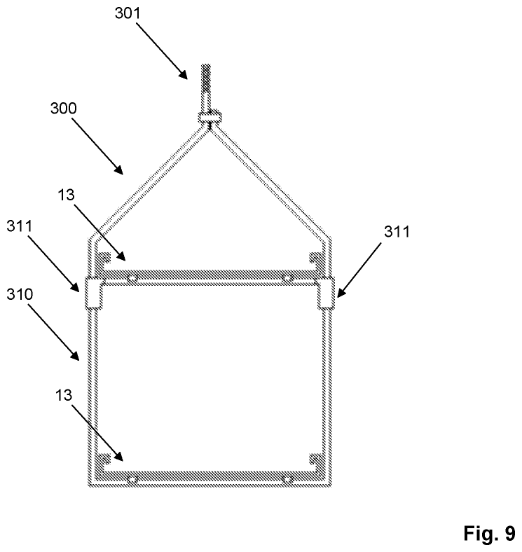

FIG. 9 shows a support according to an embodiment of the present invention;

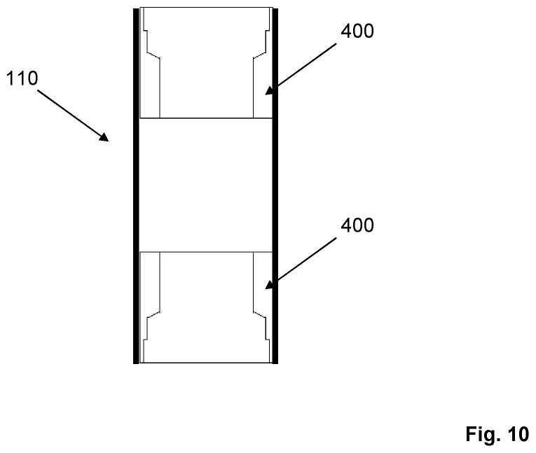

FIG. 10 shows a cross-sectional view of a connector according to an embodiment of the present invention; and

FIGS. 11 to 13 illustrate the operation of the connector of FIG. 10.

FIG. 2 shows a support 10 according to an embodiment of the invention. It is formed from a unitary steel bar, which is bent into the shape shown. It comprises an upper arranged to hang vertically from an upper support (not shown). The lower part comprises two portions arranged substantially as two adjacent sides of a triangle, such that the lowest portion is arranged to be substantially horizontal in use and to receive a cable tray 13. The cable tray 13 is held in position by means of suitable clips. These are the subject of a patent application (WO2019110979), the relevant details of which are incorporated herein.

The space inside the generally triangular space is designated with dashed lines 30. This space is herein termed the accommodation space and indicates an area within the bounds of the support where a cable or pipe may be accommodated on, if required, a cable tray. In each of the following embodiments, an accommodation space is present and it is similarly indicated by dashed lines and labelled 30, even if the shape defined by it differs. The accommodation space is always arranged such that a pipe or cable may enter the accommodation space by intersecting a plane of the accommodation space from a side. In the prior art trapeze of FIG. 1, a pipe or cable enters the accommodation space (the generally square space shown) by penetrating the plane in a direction transverse to the plane. It is not possible to enter from the side by intersecting a plane of the accommodation space.

The cable tray 13 is arranged to receive one or more cables or pipes 12 as shown. The left hand drawing shows how the cables or pipes may be placed into the support 10 to rest on the tray 13. The left hand view shows the pipes or cables in situ, once fitted.

As can be seen, each support 10 is essentially unitary and requires only the fitting of a cable tray 13 in order to render it functional. A run of such supports can be easily fitted and then the utilities (i.e. the cables or pipes) can be fitted afterwards by means of side-entry as shown.

Unlike the prior art trapeze 1, shown in FIG. 1, the embodiment shown in FIG. 2 has several advantages. Firstly, being a substantially unitary part, it does not require cutting to size and may be provided in a range of suitable sizes. This reduces fitting time and reduces the risk of injury to the fitter. Secondly, with the prior art trapeze 1, once the run of trapezes has been installed, it is necessary to load the pipes or cables from one end and then pull them along the entire length of the run to get them into position. This is not only arduous, but it can damage the pipes or cables in the process. Similarly, if a cable or pipe needs to be replaced or repaired after fitting, it must be withdrawn from the run from one end and then repositioned, risking further damage in the process.

With the embodiment shown in FIG. 2, the pipes or cables 12 may be placed into the support 10 by means of the open side of the support. In this way, the pipes or cables do not need to be physically pulled along the entire length of the run, meaning that the activity is less arduous and also minimise the risk of damage to the pipes or cables in the process.

In a further advantage, new fire regulations are being proposed which may mandate that, in the event of a fire, pipes or cable which are or which may be affected, should be removed rapidly, since fire can spread along such pipes or cables, thereby facilitating the spread of the fire. In such circumstances, it may be necessary to rapidly remove pipes or cables from supports. By use of the supports shown in FIG. 2, the cables or pipes can be easily and quickly removed by means of a hooked pole or similar.

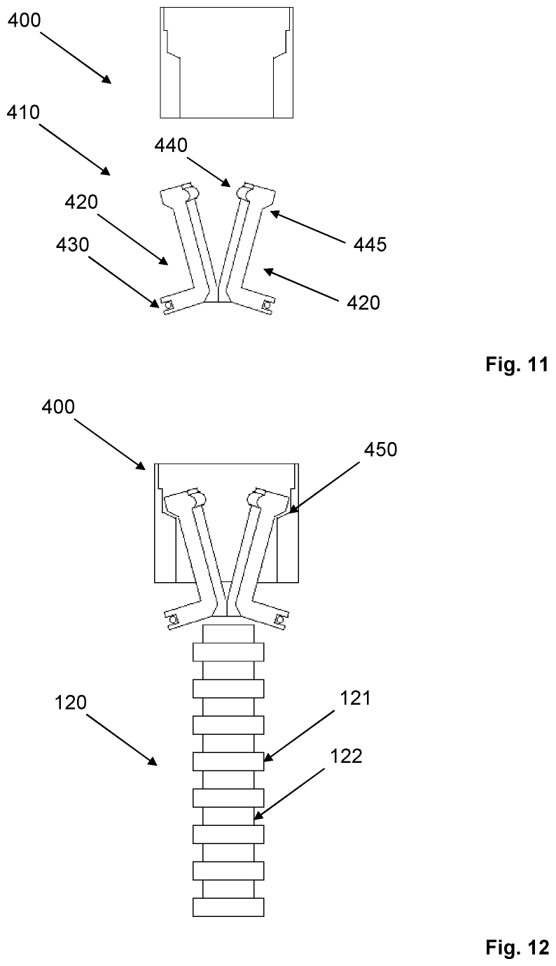

In order to secure the support 10 to a ceiling or other suitable surface, attachment means 11 is provided. In the embodiment shown here, this takes the form of a short castellated section at an uppermost free end. By “castellated”, it is meant that the section includes a series of waisted portions of smaller diameter than the surrounding portions. This arrangement allows simple and speedy connection to a suitable connector. The details of this connector are presented briefly in FIGS. 11 and 12.

A receiver 400 may be located in a ceiling. The receiver may be driven into the ceiling or may form part of a further anchor system.

Located within the receiver 400 is a retaining device 410. This is shown in FIG. 11 outside the receiver for clarity.

The retaining device 410 comprises a matching pair of members 420. Each is semi-annular arranged to form a complete annulus, with a central axial aperture, when assembled.

Each member 420 comprises an inner circumferential ridge 440 adjacent an upper part of the member. The ridge 440 is substantially curved and is arranged to protrude into an inner hollow of the member 420. The ridge may be continuous or discontinuous i.e. a series of projections.

Each member 420 also comprises an outer circumferential projection 445 which comprises an angled lower portion. The projection may be continuous or discontinuous i.e. a series of projections.

Each member 420 comprises a channel adjacent a lower part of the member. The channel forms a complete circular recess once the two members 420 are placed adjacent each other as shown in FIG. 2. A split ring or spring clip 430 is provided to sit in the channel and maintain the two members in close proximity for use.

The members 420 and split ring 430 are preferably formed from a metal, most preferably steel. They are formed to be fireproof and able to withstand high temperatures and to be mechanically strong.

FIG. 12 shows a receiver 400, which is arranged to receive the retaining device 410. The receiver 400 is formed from the same material as the retaining device 410 and is substantially cylindrical with a central aperture to receive the retaining device 410. The aperture is relatively wider at an upper end, and the transition between the lower narrower part and the upper wider part is marked by angled surface 450.

The receiver 400 is arranged to be attached to a supporting surface. The supporting surface may suitably by a ceiling and it may be attached thereto by means of a fastening such as a screw or bolt (not shown) which passes through an upper surface of the receiver 400 and into the supporting surface. A fixing aid such as a plug, anchor or similar may be provided if necessary, to provide a secure fixing. The receiver may, alternatively, be integrally formed with an attachment device so that the entire receiver may be attached to a suitable surface. This may take the form of an integral screw element, for instance. In a still further embodiment, the receiver 400 is arranged to itself be received into a pre-positioned rail system, allowing a plurality of receivers 400 to be positioned in the rail in an elongate manner. Essentially, the receiver may be fastened in any number of ways to a supporting surface, The details of such attachment are intendent of the operation of embodiments of the invention.

In use, the retaining device 410 is inserted into the receiver 400. To do this, the upper parts of the device 410 are pressed towards each other. This requires minimal force and may be provided easily in a manual manner with no tool required. Once in this ‘closed’ position, the upper part of the retaining device 410 is inserted into the receiver 400. This is illustrated in FIG. 12. Once the upper part of retaining device 410 is inserted, it naturally reverts to the default ‘open’ configuration as shown. In this way, the retaining device is temporarily retained loosely within the receiver 400. It is prevented from falling out by a combination of the force which tends to hold it in the ‘open’ position and the cooperation of the outer circumferential projection 445 which comprises an angled lower portion which rests on the angled surface 450 within the receiver 400.

With the retaining device 410 retained in the receiver 400, the next step is to introduce castellated rod 120. The rod 120 is elongate and of a width to be accommodated within the retaining device 410. Along at least a part of its length it has alternating protruding portions 121 and recessed or waisted portions 122.

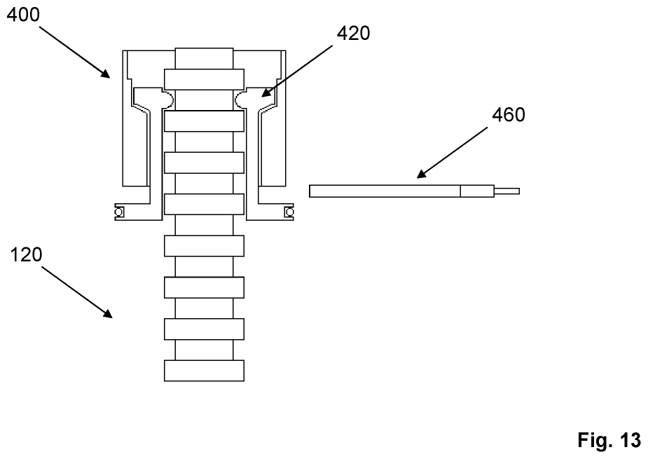

In order to insert the rod 120 into the retaining device 410, it is necessary to provide sufficient upward force to overcome the biasing force provided by the split ring 430. In this way, the rod penetrates the retaining device and travels upwards until it reaches the upper portion of the receiver 400. Once in this position, the upper parts of the retaining device are forced relatively inwards, towards each other, and the inner circumferential ridge 440 is urged towards the rod 120 and naturally engages with the waisted portion 122. This is shown in FIG. 13.

As can be seem, the two members 420 are now substantially parallel with each other and the retaining device 410 fits snugly around the rod 120, In this configuration, downward force on the rod 120 actually serves to secure the retaining device 420 more securely in position. In order to lock the configuration, locking member 460 is positioned between the opposed lower surfaces of the retaining device 410 and receiver 400 as shown. Locking member 460 is formed in a substantially planar C-shape and is dimensioned to be resiliently deformable and is held in position by its natural resilience. It can be formed from metal, such as steel, for fire-safe applications. In other applications, it can be formed from a plastic material.

As long as there is a steady downward force on the rod 120, it will remain static. The locking member 460 is provided for additional stability and can guard against vibrations.

In order to dismantle the assembly, if required, the locking member is removed and the castellated rod may be removed in a downward direction while a relatively upward force is applied to the retaining device 410.

This manner of fixing may be used for any of the embodiments presented herein. Alternatively, other fixings known in the prior art may be used.

FIG. 3 shows a further embodiment of the invention in the form of pipe support 20. The support 20 is arranged to be fixed to a ceiling or other surface by means of attachment portion 21 as described in relation to the embodiment of FIG. 1. The support 20 comprises a first portion 21 which is essentially hook-like and arranged to receive a pipe 24.

In the same way as described for the embodiment of FIG. 1 a run of several portions 21 can be fitted and then a length of pipe introduced to rest in the hook-like portion at a lower end of portion 21, as shown in the central part of FIG. 3.

Once the pipe has been fitted as shown, the second portion 23 of the support 20 can be introduced. The second portion 23 essentially closes the open part of the hook-like portion and secures the pipe 24 in place. This is achieved by means of a collar 26 provided on the free end of the hook-like portion. The collar is a ring-like structure which fits snugly on the free end as shown and can accommodate a first free end of the second portion 23. Once the second portion is in place, then it is secured in place by means of a fixing device 25 which is pre-installed on the first portion and which grasps the second free end of the second portion 23 so that it is attached securely to the first portion, thereby securing the pipe in position.

If the pipe needs to be removed, then it is a simple task to remove the fixing device 25, thereby allowing the second portion 23 to be removed and thereby allowing the pipe 24 to be removed.

FIG. 4 shows a slight variant of the embodiment shown in FIG. 2. Here, a double-layered support is formed from the support 10 of FIG. 2, used in conjunction with a similar support 10′ having altered dimensions which permit it to sit within the open area of the first support in which pipes or cables are carried.

As can be seen, this is achieved by making the first angled portion of the second support 10′ significantly shorter than the corresponding portion of the first support 10. Then, by mounting both supports adjacent to each other in the ceiling or other support, each support can be independently loaded from the side as described previously.

Such a configuration is useful in situations where space is limited and there is a need to convey more pipes or cables than can be carried in a single support. Further, this arrangement may be useful to segregate a first type of pipe or cable (e.g. high voltage cables) from a second type (e.g. communications or data cables).

FIG. 5 shows a further embodiment. This is similar for the embodiment of FIG. 2, but provide certain additional functions and flexibility.

An anchor 100 is provided which has a threaded end 101 and a castellated portion 102. The threaded portion is arranged to be screwed into a supporting surface, such as a ceiling, in a known manner. Alternatively, the threaded portion may be omitted and the castellated portion may connect to a receiver 400 as previously described.

In the embodiment shown, the castellated portion 102 then protrudes from the ceiling.

A connector 110 then connects the castellated portion 102 to a similar castellated portion 201 provided on support 200. The connector 110 is shown in FIG. 10. It essentially comprises an elongate tube in which is provided a pair of receivers 400, described already. Each one of these receivers 400 is able to receive a retaining device 410, which then enables a castellated rod 120 to be accommodated at each end of the connecting device 110.

The basic structure of the support 200 is similar to the support 10 shown in FIG. 2. It is arranged to receive a cable tray 13 to support one or more pipes or cables 12. At the free end of the support 200 is a further castellated portion 202, whose function will be described in the following description of FIG. 6.

As shown, the open side of the support facilitates easy access to the support so that pipes or cables can be added via side access as in the previous embodiments. By “side access”, it is meant that cables or pipes can be introduced in a manner which does not require them to be pulled along a run of a plurality of supports, as happens in the prior art trapeze arrangement of FIG. 1. The accommodation area of the trapeze of FIG. 1 is a closed, bounded, area and so the only way that cables or pipes can be introduced into a plurality of such devices, once installed, is along the same direction as the run of the plurality of trapezes.

In contrast, in embodiments of the present invention, a run of a plurality of supports can be installed and one or more cables may then be laid on the floor following the general path of the plurality of supports and then simply lifted into position and introduced from the side of the supports, without the need to pull them along the length of the run of supports.

In some circumstances, it can be desirable to provide additional support and rigidity to the support shown in FIG. 5. In such circumstances, the support of FIG. 5 may be supplemented as shown in FIG. 6. Here, the castellated portion 202 at the free end of the support 200 is attached to connector 110, which in turn is connected to a length of castellated rod 120, which is then connected via another connector 110 to a further anchor 100 fitted into the support structure. This additional support provides additional strength to the support and allows it to carry greater weight if required.

If access is required to a pipe or cable, then one or both connectors 110 may be removed to permit side access to the pipes or cables.

FIG. 6 shows a side view of a run of several supports as shown in FIG. 5. As can be seen, the supports are spaced at intervals which may be determined based on a load calculation.

FIG. 7 shows a further embodiment of the present invention. Support 300 is formed from a single length of steel, bent as needed. An upper free end 301 is provided with a castellated portion as described previously, to allow the support to be secured in an anchor point.

The lower portion is arranged in a generally triangular shape with a lower horizontal portion being arranged to receive the cable tray 13. The steel from which the support 300 is constructed is naturally relatively springy and without the fixing element 302, the free end 303 of the support tends to spring away from the generally vertical portion, thereby opening the triangular section. This allows access to the interior of the triangular section and, particularly, the cable tray 13, so that cables or pipes can be introduced in a side-access manner as per the previous embodiments. Once the cables or pipes have been introduced, the free end 303 is moved towards the vertical portion of the support and the fixing element 302, which has been previously slid over the vertical portion, is slid into position such that the free end 303 is held in position adjacent to the vertical portion thereby closing the triangular section, keeping the cables or pipes securely in position.

The fixing element 303 is formed from a metal, preferably steel, such that in the event of a fire, the entire support structure maintains its structural integrity.

FIG. 8 shows a further embodiment of the present invention, derived from the embodiment shown in FIG. 7. In this case, the support 300 of FIG. 7 is provided with an additional capacity by means of a supplemental support 310, which houses a further cable tray 13. The supplemental support 310 is connected to the support 300 by means of a pair of connectors 311 which couple the free ends of generally U-shaped support 310 to the underside of the support 300. The connectors 311 can take any required form, depending upon the dimensions and/or other characteristics of the respective parts to be connected. At one simple extreme, a twisted wire will suffice. At another extreme, a custom part may be utilised, as understood by the skilled person.

Embodiments of the invention allow simple coupling of a support to a supporting surface, such as a ceiling. This may be achieved via means of a castellated rod, retaining device and receiver or via other known means. Where a particular embodiment is shown using a particular type of fixing, this is illustrative only and other fixings can be employed as required.

Further, each embodiment allows side access to the interior of the support structure so that cables or pipes can be introduced to or removed from the support without the need to pull the pipes or cables along the length of the run of supports. In the prior art, trapezes are typically constructed such that side access is not possible and the bounds of the trapeze in which the pipes or cables are located is closed and cannot be easily opened. This is in contrast to embodiments of the present invention where the space in which the pipes or cables are located is permanently open (as in FIGS. 2 and 5) or can be simply opened to allow rapid access to the pipes or cables located therein (as in FIGS. 3, 6 and 7).

Although the example embodiments shown herein illustrate the support arranged to be suspended from a ceiling or other horizontal surface, the skilled person will appreciate that each may be adapted to extend horizontally or at some other angle, from an upright or other surface.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A support apparatus suitable for supporting a cable or a pipe, wherein the support apparatus once installed to a suitable supporting surface, is arranged to provide an accommodation space which is at least partially open at an opening such that the cable or pipe may be introduced into the accommodation space through the opening.

2. The support apparatus as claimed in claim 1 wherein the support apparatus is arranged such that the cable or pipe may be introduced into the accommodation space from a side of the support apparatus.

3. The support apparatus as claimed in claim 2 wherein a plurality of support apparatuses are provided and the pipe or cable may be introduced into the plurality of support apparatuses simultaneously, rather than sequentially.

4. The support apparatus of claim 1, wherein the support apparatus comprises, in use, a substantially vertical support, an angled intermediate support and a substantially horizontal support, wherein the accommodation space is substantially triangular, bounded on two sides the intermediate support and the horizontal support.

5. The support apparatus of claim 4 formed from a bent unitary elongate member.

6. The support apparatus of claim 4, further comprising a second support apparatus as claimed in claim 4 wherein the substantially vertical support of the second support apparatus is shorter than that of the first support apparatus, such that two separate runs of pipes or cables are thereby formed.

7. The support apparatus of claim 1, wherein the support apparatus comprises, in use, a substantially vertical support and a substantially arcuate pipe support portion, defining a substantially circular accommodation space.

8. The support apparatus of claim 7 further comprising an arcuate closing portion, arranged to substantially close the accommodation space.

9. The support apparatus of claim 8 wherein the arcuate closing portion is arranged to couple at each of its two free ends to the support apparatus.

10. The support apparatus of claim 4 wherein, in use, a lower free end of the support apparatus is provided with means for coupling to a further support for additional support.

11. The support apparatus of claim 10 further comprising the additional support, arranged to be fixed to the suitable supporting surface.

12. The support apparatus of claim 11 wherein the support apparatus and additional support are arranged to be coupled by means of a castellated portion on each and a connector.

13. The support apparatus of claim 1, wherein the accommodation space is bounded on all sides, but may be opened/closed by means of a suitable fixing device.

14. The support apparatus of claim 13 wherein the support apparatus is formed from a bent unitary rod and the accommodation space is formed in a generally triangular shape, with one side of the triangle is arranged to spring free from the support apparatus to facilitate introducing the cable or pipe.

15. The support apparatus of claim 13 comprising a further support apparatus arranged to be fastened to the support apparatus to accommodate another pipe or cable.

16. A plurality of support apparatuses of claim 1 further comprising a cable tray arranged to span a gap between two or more of the plurality of support apparatuses.
